(19) United States
(12) Patent Application Publication
(10) Pub. No.: US 2026/0108845 A1
(43) Pub. Date: Apr. 23, 2026

(54) HYBRID MEMBRANE AND PRESSURE SWING ADSORPTION NITROGEN REMOVAL SYSTEM

(71) Applicants: Air Liquide Advanced Technologies U.S. LLC., Houston, TX (US); L'Air Liquide, Sociêtê Anonyme Pour I'Etude et I'Exploitation des Procêdês Georges Claude, Paris (FR)

(72) Inventors: Alexander S. AUGUSTINE, Newark, DE (US); Paul TERRIEN, Syracuse, NY (US); Philippe COIGNET, Wilmington, DE (US)

(21) Appl. No.: 18/920,018

(22) Filed: Oct. 18, 2024

(51) Int. Cl. B01D 53/22; B01D 53/047; C10L 3/10

(52) U.S. Cl. CPC B01D 53/229; B01D 53/047; B01D 53/226; C10L 3/105; B01D 2256/245; B01D 2257/102; C10L 2290/548

(57) ABSTRACT

A process for removing nitrogen from a feed gas containing at least nitrogen and methane comprises
a) introducing the feed gas into a first membrane stage to produce a first permeate enriched in methane and a first residue enriched in nitrogen;
b) forwarding the first residue into a second membrane stage to produce a second permeate enriched in methane and a second residue enriched in nitrogen;
c) forwarding the second residue into pressure swing adsorption (PSA) beds to produce an high pressure overhead stream containing nitrogen and a low pressure offgas stream containing methane therein;
d) combining the second permeate enriched in methane and the low pressure offgas stream containing methane to form a combined gas and forwarding the combined gas to the feed gas for recycle;
e) collecting a first permeate enriched in methane as a product; and
f) venting out the high pressure overhead stream containing nitrogen.

### TECHNICAL FIELD

The present invention relates to a hybrid membrane and pressure swing adsorption (PSA) system for removing nitrogen from a raw natural gas, in particular, to a combination of two membrane stages and a PSA system with multiple configurations based on a fraction of nitrogen in the raw natural gas.

### BACKGROUND

A sizable fraction of natural gas wells and landfill gas sources contain nitrogen levels exceeding the typical pipeline specification of 3 mol %. The most common method of nitrogen rejection is cryogenic separation; however, it is only applicable at large scale due to the complexity and high capital cost. There are only limited solutions to remove nitrogen from natural gas at small to mid-scale. Both membrane and pressure swing adsorption (PSA) systems have been used at these scales, however, only a limited recovery of hydrocarbons has been achieved. The proposed invention allows for high recovery exceeding 95% while maintaining a reasonable cost at small scale.

Several examples of membrane systems for nitrogen removal have been patented previously.

EP0684066 describes a two-stage hybrid process for helium or hydrogen purification. The process utilizes a first stage of rubbery membranes to enrich the product, then a second stage of pressure-swing adsorption to achieve a high purity product.

JP2015091918 describes a two-stage hybrid process for nitrogen removal from a natural gas or biogas stream. The process utilizes a first stage of glassy membranes to reject some nitrogen, then a second stage of pressure-swing adsorption to achieve an on-spec product.

U.S. Pat. No. 5,174,796 describes a conventional equilibrium driven pressure-swing adsorption process for nitrogen rejection. The cycle uses a co-current purge step to increase methane purity while retaining reasonable recovery.

U.S. Pat. No. 6,444,012 describes a two-stage conventional equilibrium driven pressure-swing adsorption process for nitrogen rejection. The low-pressure methane rich product of the first stage is used to regenerate the first stage beds. This allows for greater overall hydrocarbon recovery.

U.S. Pat. No. 2,843,219 describes a kinetic pressure swing adsorption process for nitrogen rejection. The methane is retained at high pressure while the nitrogen is rejected at low pressure. This process is significantly hindered in terms of hydrocarbon recovery.

U.S. Pat. No. 6,425,267 describes a two-stage membrane process for nitrogen removal from a natural gas or biogas stream. The permeate of the first stage is enriched in methane to meet a product specification. The permeate from the second stage is recycled to the feed compressor for enhanced recovery.

U.S. Pat. No. 6,630,011 describes a three-stage membrane process to remove nitrogen from a natural gas or biogas stream. The methane-rich permeate from the first stage is sent to a second stage at intermediate pressure. The methane-rich permeate from the second stage is the product which meets a pipeline specification. The retentate from the first stage is sent to a third stage which rejects nitrogen in the permeate stream. Rubbery polymer membranes are used for the first and second stage. A glassy polymer membrane is used for the third stage.

A natural gas stream that contains more than 3% nitrogen is typically below pipeline quality due to high concentration of inserts and insufficiently low heating value. At a large scale, a cryogenic nitrogen rejection unit is typically used to upgrade the gas. Considering small scale, with a feed gas flow of less than approximately 10 MMSCFD, a cryogenic plant is not economically viable. Additionally, for a nitrogen content of less than approximately 15 mol %, cryogenic separation cannot be achieved using the expansion of the rejected nitrogen alone; additional compression energy is required. With regard to smaller scale applications and N₂ content between 5-15%, a single stage or two-stage membrane system is unsuitable due to the low recovery constraint. Membranes have insufficient CH₄/N₂ or N₂/CH₄ selectivity to achieve simultaneous product purity and methane recovery. A three-stage membrane process can achieve both; however, it typically requires multiple recycle compressors at significant capital cost. At smaller scale, and N₂ content less than 30%, the application of equilibrium PSA alone is challenged by the large quantity of adsorbent required. Additionally, due to the low selectivity, two or more stages are required to achieve both product purity and high recovery. At smaller scale, and N₂ content exceeding approximately 8%, the application of kinetic PSA alone is challenged by the low recovery which can be achieved without the simultaneous use of complex vacuum compressors and internal recycling.

### SUMMARY

There is disclosed a process for removing nitrogen from a feed gas containing at least nitrogen and methane, the process comprising the steps of:
a) introducing the feed gas into a first membrane stage to produce a first permeate enriched in methane and a first residue enriched in nitrogen;
b) forwarding the first residue enriched in nitrogen into a second membrane stage to produce a second permeate enriched in methane and a second residue enriched in nitrogen;
c) forwarding the second residue enriched in nitrogen into pressure swing adsorption (PSA) beds to produce an high pressure overhead stream containing nitrogen and a low pressure offgas stream containing methane therein;
d) combining the second permeate enriched in methane and the low pressure offgas stream containing methane to form a combined gas and forwarding the combined gas to the feed gas for recycle;
e) collecting a first permeate enriched in methane as a product; and
f) venting out the high pressure overhead stream containing nitrogen.

In some embodiments, the process further comprises the step of:
compressing the feed gas before feeding the feed gas to the first membrane stage.

In some embodiments, the process further comprises the step of:
compressing the combined gas before forwarding the combined gas to the feed gas for recycle.

In some embodiments, the process further comprises the steps of: if the feed gas containing exceeding 6 mol % but not greater than 10 mol % of nitrogen,
splitting the feed gas into a first and a second feed streams;
forwarding the first feed stream to the first membrane stage, wherein the first feed stream is merged with the combined gas before forwarding the first feed stream to the first membrane stage;
forwarding the second feed stream to the second membrane stage, wherein the second feed stream is merged with the first residue enriched in nitrogen from the first membrane stage before forwarding the second feed stream to the second membrane stage; and
moderating a ratio of the feed gas in the first and second feed streams, respectively.

In some embodiments, the process further comprises the steps of:
compressing the feed gas before splitting the feed gas.

In some embodiments, the process further comprises the steps of:
compressing the combined gas before forwarding to the first membrane stage.

In some embodiments, the process further comprises the steps of: if the feed gas containing exceeding 10 mol % but not greater than 20 mol % of nitrogen, the steps of:
a) splitting the feed gas into a first and second feed streams;
b) forwarding the first feed stream to the second membrane stage, wherein the first feed stream is merged with the first residue enriched in nitrogen from the first membrane stage before forwarding the first feed stream to the second membrane stage;
c) forwarding the second feed stream to the pressure swing adsorption (PSA) beds, wherein the second feed stream is merged with the second residue enriched in nitrogen from the second membrane stage before forwarding the second feed stream to the pressure swing adsorption (PSA) beds; and
d) moderating a ratio of the feed gas in the first and second feed streams, respectively.

In some embodiments, the process further comprises the steps of:
compressing the feed gas before splitting the feed gas.

In some embodiments, the process further comprises the steps of:
compressing the combined gas before forwarding to the first membrane stage.

There is disclosed a membrane system for removing nitrogen from a feed gas containing at least nitrogen and methane, the system comprising:
a) a first membrane stage, fed with the feed gas, configured to produce a first permeate enriched in methane and a first residue containing nitrogen;
b) a second membrane stage, fed with the first residue containing nitrogen, configured to produce a second permeate enriched in methane and a second residue enriched in nitrogen;
c) a pressure swing adsorption (PSA) system containing PSA beds, fed with the second residue enriched in nitrogen, configured to produce an high pressure overhead stream containing nitrogen and a low pressure offgas stream containing methane therein; and
d) a combined gas, formed by combining the second permeate enriched in methane and the low pressure offgas stream containing methane, wherein the combine gas is forwarded to the feed gas for recycle, the high pressure overhead stream containing nitrogen is vent out, the first permeate enriched in methane is collected as a product.

In some embodiments, the membrane system further comprises:
a compressor, configured to compress the feed gas before the feed gas is fed to the first membrane stage.

In some embodiments, the membrane system further comprises:
a compressor, configured to compress the combined gas before the combined gas is forwarded to the feed gas for recycle.

In some embodiments, the membrane system further comprises: if the feed gas containing exceeding 6 mol % but not greater than 10 mol % of nitrogen,
a splitter, configured to split the feed gas into a first and a second feed streams; and
two control valves, each installed along the first and second feed streams, respectively, configured to moderate a fraction of the feed gas in the first and second feed streams,
wherein the first feed stream is fed to the first membrane stage and the second feed stream is fed to the second membrane stage.

In some embodiments, the membrane system further comprises:
a compressor, configured to compress the feed gas before the feed gas is forwarded to the splitter.

In some embodiments, the membrane system further comprises:
a compressor, configured to compress the combined gas before the combined gas is forward to the first membrane stage.

In some embodiments, the membrane system further comprises: if the feed gas containing exceeding 10 mol % but not greater than 20 mol % of nitrogen,
a splitter, configured to split the feed gas into a first and a second feed streams; and
two control valves, each installed along the first and second feed streams, respectively, configured to moderate a fraction of the feed gas in the first and second feed streams,
wherein the first feed stream is fed to the second membrane stage and the second feed stream is fed to the pressure swing adsorption (PSA) system.

In some embodiments, the membrane system further comprises:
a compressor, configured to compress the feed gas before the feed gas is forwarded to the splitter.

In some embodiments, the membrane system further comprises:
a compressor, configured to compress the combined gas before the combined gas is forward to the first membrane stage.

In some embodiments, the first membrane stage and the second membrane stage each comprise rubbery-type hollow-fiber membranes.

In some embodiments, the rubbery-type hollow-fiber membrane comprises poly(dimethyl siloxane) (PDMS) selected from homopolymers of dimethylsiloxane, copolymers of dimethyl siloxane with methylethyl siloxane, methyl propyl siloxane, methyl butyl siloxane, methyl pentylsiloxane, methyl hexyl siloane, methyloxtyl siloane, or methyl phenyl siloxane.

In some embodiments, the rubbery-type hollow-fiber membrane comprises block copolymers of dimethylsiloxane, methyloctylsiloxane with polyarylethers, polyamides, polyesters, polyketones, polyimides, dimethyl siloxanes or methyl octyl siloxane with silicates.

In some embodiments, the rubbery-type hollow-fiber membrane comprises a ladder-type silicone block copolymer with a general formula of: HO{[C₆H₅SiO1.5]ₙ[Si(CH₃)₂O]ₘ}H, where n=30-60, and m=80-130.

There is disclosed a process for removing nitrogen from a feed gas containing at least nitrogen and methane, when the feed gas containing exceeding 10 mol % but not greater than 20 mol % of nitrogen, the process comprising the steps of:
a) splitting the feed gas into a first and second feed streams;
b) moderating a ratio of the feed gas in the first and second feed streams, respectively;
c) forwarding the first merged gas to the second membrane stage, wherein the first feed stream is merged with a first residue enriched in nitrogen from a first membrane stage before forwarding the first merged gas to the second membrane stage;
d) forwarding the second merged gas to pressure swing adsorption (PSA) beds to produce an high pressure overhead stream containing nitrogen and a low pressure offgas stream containing methane therein, wherein the second feed stream is merged with a second residue enriched in nitrogen from the second membrane stage before the second merged gas to pressure swing adsorption (PSA) beds, and;
e) combining a second permeate enriched in methane from the second membrane stage and the low pressure offgas stream containing methane from the PSA beds to form a combined gas and forwarding the combined gas to the first membrane stage as a first stage feed gas;
f) compressing the combined gas before forwarding the combined gas to the first membrane stage;
g) collecting a first permeate enriched in methane as a product; and
h) venting out the high pressure overhead stream containing nitrogen.

There is disclosed a process for removing nitrogen from a feed gas containing at least nitrogen and methane, when the feed gas containing exceeding 6 mol % but not greater than 10 mol % of nitrogen, the process comprising the steps of:
a) splitting the feed gas into a first and second feed streams;
b) moderating a ratio of the feed gas in the first and second feed streams, respectively;
c) forwarding the first feed stream to the first membrane stage, wherein the first feed stream is merged with the compressed combined gas before forwarding the first feed stream to the first membrane stage;
d) forwarding the second feed stream to the second membrane stage, wherein the second feed stream is merged with the first residue containing nitrogen from the first membrane stage before forwarding the second feed stream to the second membrane stage; and
e) combining a second permeate enriched in methane from the second membrane stage and the low pressure offgas stream containing methane from the PSA beds to form a combined gas and forwarding the combined gas to the first membrane stage as a first stage feed gas;
f) compressing the combined gas before forwarding the combined gas to the first membrane stage;
g) collecting a first permeate enriched in methane as a product; and
h) venting out the high pressure overhead stream containing nitrogen.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a block diagram of an exemplary embodiment of a hybrid membrane and PSA Nitrogen removal system in accordance with the present invention;

FIG. 2 is a block diagram of another exemplary embodiment of a hybrid membrane and PSA Nitrogen removal system in accordance with the present invention;

FIG. 3 is a block diagram of another exemplary embodiment of a hybrid membrane and PSA Nitrogen removal system in accordance with the present invention; and

FIG. 4 is a block diagram of another exemplary embodiment of a hybrid membrane and PSA Nitrogen removal system in accordance with the present invention.

### DESCRIPTION OF PREFERRED EMBODIMENTS

Disclosed is a hybrid membrane and pressure swing adsorption (PSA) nitrogen removal system and a process for N₂ removal from natural gas wells and landfill gas sources with a combination of membranes and PSA. More specifically, a first membrane stage of the hybrid membrane is used to generate pipeline quality natural gas in a permeate stream while retaining a nitrogen-rich retentate stream. The nitrogen-rich retentate stream is sent to a second membrane stage of the hybrid membrane which allows for recycle of a methane-rich permeate stream from the second membrane stage. A retentate stream from the second membrane stage is sent to an equilibrium-type PSA system which allows for recycle of a methane-rich offgas stream enriched in methane. Then two recycle streams, the methane-rich permeate stream from the second membrane stage and the methane-rich offgas stream from the PSA system are combined. The combined two recycle streams is sent to a compressor to compress to a higher pressure that meets a pressure of an incoming feed gas. The compressed combined two recycle streams is then mixed with the incoming feed gas and fed to the first membrane stage. A vent gas containing N₂ is flare or vent out from the PSA beds.

The disclosed hybrid membrane system comprises two stages of membranes, stage 1 and stage 2 membranes, which are used in series, followed by a conventional equilibrium-type PSA process. A permeate stream from the stage 1 membrane consists of pipeline quality natural gas and has a pressure lower than the feed gas of the stage 1 membrane. The pressure of the permeate stream from stage 2 membrane is lower than that of the feed of stage 1 membrane and is compressed and recycled to stage 1 membrane as a feed. An offgas from the PSA is enriched in methane and has a pressure lower than that of a residue stream from stage 2 membrane, it is combined with and compressed and recycled to stage 1 membrane as a feed. Before compression, the permeate stream from stage 2 membrane and the offgas from the PSA are combined and forwarded to a compressor.

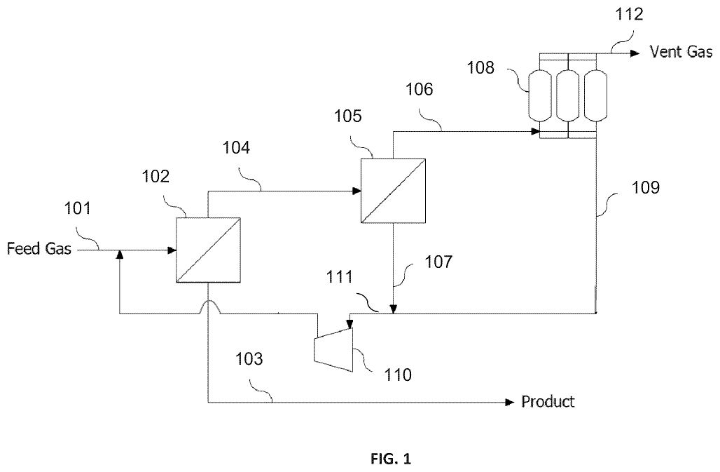

An embodiment of the disclosed hybrid membrane system is shown in FIG. 1. As shown, feed gas 101 is introduced into first membrane permeation stage 102. Feed gas 101 may be a high-pressure raw natural gas that may at least contain methane and nitrogen. The high-pressure raw natural gas may be from natural gas wells or landfill gas sources that is high-pressure or from an upstream compressor. The pressure range for the high-pressure raw natural gas may be from 15-80 barg, preferably 50 barg. The pressure of the high-pressure raw natural gas may be formed by a gradual pressurization process at a rate of 10 bar/min or less, preferably 5 bar/min. The feed gas stream may be any other streams containing at least methane and nitrogen. Permeate 103 from first membrane permeation stage 102 is recovered as a methane product, a pipeline quality natural gas, depleted in N₂ while residue 104 enriched in N₂ from first membrane permeation stage 102 is introduced into second membrane stage 105. Permeate 107 from second membrane stage 105 enriched in methane is then recycled to feed gas 101 while residue 106 containing nitrogen of second membrane stage 105 is introduced into pressure swing adsorption (PSA) beds 108. In PSA beds 108 methane contained in residue 106 of second membrane stage 105 is adsorbed on some adsorbent layers and then regenerated by reducing pressure. Residual high pressure gas or PSA overhead gas 112 enriched in N₂ as a waste gas is flared or vented out from PSA beds 108. Regenerated gas or PSA offgas 109 from PSA beds 108 is combined with permeate 107 from second membrane stage 105 and recycled to feed gas 101. Combined stream 111 of permeate 107 from second membrane permeate 105 and regeneration gas 109 from PSA beds 108 is sent to single compressor 110 for recompressing before merging with feed stream 101.

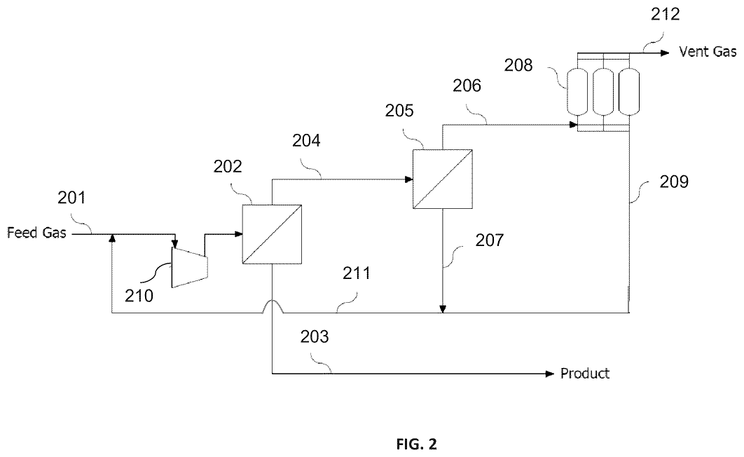

FIG. 2 shows another embodiment of the disclosed hybrid membrane system. As shown, feed gas 201 is available at low pressure ranging from 0.8 to 5 barg, preferably 2 barg, and is initially compressed by compressor 210 and introduced into first membrane stage 202. Permeate 203 from first membrane stage 202 is recovered as methane product depleted in N₂ while residue 204 enriched in N₂ from first membrane stage 202 is introduced into second membrane stage 205. Permeate 207 from second membrane stage 205 is then recycled to feed gas 201 while residue 206 of second membrane stage 205 is introduced into PSA beds 208. Residual high pressure gas or PSA overhead gas 212 from PSA beds 208 is enriched in nitrogen as a waste gas to be flared or vented out. Regenerated gas or PSA offgas 209 from PSA beds 208 is recycled to feed gas 201. Combined streams 211 combined from second membrane permeate 207 and regeneration gas 209 from PSA beds 208 is recycled by mixing with the feed gas 201 prior to entering feed compressor 210.

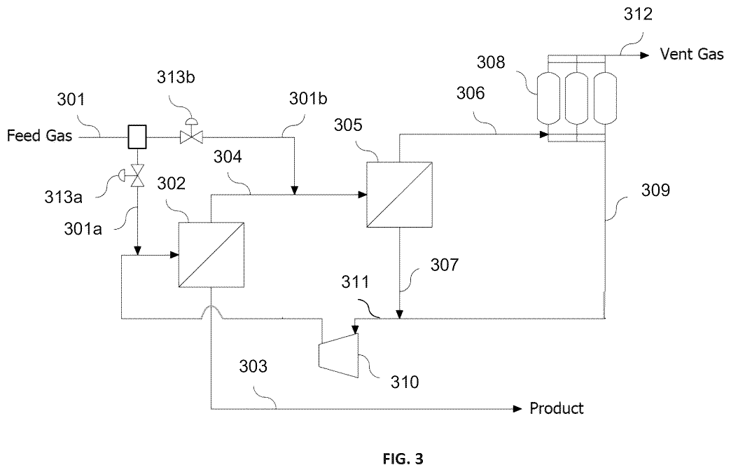

FIG. 3 shows another embodiment of the disclosed hybrid membrane system. In the case where incoming feed gas 301 contains a greater mole fraction of nitrogen, e.g., exceeding 6 mol % but not greater than 10 mol %, feed gas 301 may be split into separate streams 301a and 301b through splitter 314. Separate stream 301b is sent directly to second stage membranes 305. Separate stream 301a is still sent to first stage membranes 302. Control valves 313a and 313b are used to moderate a fraction of feed gas 301 in separate streams 301a and 301b or a ratio of feed gas 301 in separate streams 301a and 301b and allow feed gas 301 to be split to each separate stream 301a and 301b and sent to two different points in the embodiment. The rest of this embodiment is the same as the embodiment shown in FIG. 1. Permeate 303 from this first stage is recovered as methane product depleted in N₂ while residue 304 enriched in N₂ from this first stage is introduced into second membrane stage 305. Permeate 307 from second membrane stage 305 is then recycled to first membrane stage 302 while residue 306 of second membrane stage 305 is introduced into PSA beds 308. In PSA beds 308 methane contained in residue 306 of second membrane stage 305 is adsorbed on some adsorbent layers and then regenerated by reducing pressure. Residual high pressure gas or PSA overhead gas 312 enriched in nitrogen as a waste gas is flared or vented out from PSA beds 308. Regenerated gas or PSA offgas 309 from PSA beds 308 is combined with permeate 307 from second membrane stage 305 and recycled to first membrane stage 302. Combined stream 311 combined with permeate 307 from second membrane permeate 305 and regeneration gas or PSA offgas 309 from PSA beds 308 are sent to single compressor 310 for recompressing before mixing with incoming feed gas 301. Here, feed gas 301 may be compressed right before or right after splitter 314 (not shown).

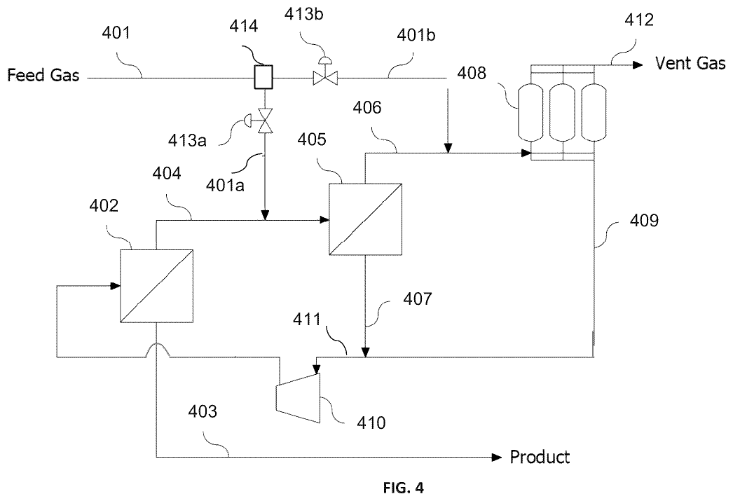

FIG. 4 shows another embodiment of the disclosed hybrid membrane system. In the case where an incoming feed gas 401 contains an even greater mole fraction of nitrogen, e.g., exceeding 10 mol % but not greater than 20 mol %, feed gas 401 may be split into separate streams 401a and 401b through splitter 414. Separate stream 401b sent directly to PSA beds 408. Separate stream 401a is then sent to second stage membranes 405. Control valves 413a and 413b are used to moderate a fraction of feed gas 401 in separate streams 401a and 401b or a ratio of feed gas 401 in separate streams 401a and 401b and allow feed gas 401 to be split to each separate stream 401a and 401b and sent to two different points in this embodiment. Another difference between FIG. 4 and FIG. 1 to FIG. 3 is a feed gas of first stage membranes 402 is combined from streams 407 and 409. Permeate 403 from this first stage is recovered as methane product depleted in N₂ while residue 404 enriched in N₂ from this first stage combined with separate stream 401a is introduced into second membrane stage 405. Permeate 407 from second membrane stage 405 is then recycled as a feed gas for first stage membranes 402 while residue 406 enriched in N₂ of second membrane stage 405 is introduced into PSA beds 408. In PSA beds 408 methane contained in residue 406 enriched in N₂ of second membrane stage 405 is adsorbed on some adsorbent layers and then regenerated by reducing pressure. Residual high pressure gas or PSA overhead gas 412 enriched in nitrogen as a waste gas is flared or vented out from PSA beds 408. Combined stream 411 combine with regenerated gas or PSA offgas 409 from PSA beds 408 and permeate 407 from second membrane stage 405 is recycled to be a feed gas for first stage membrane 402. Combined stream 411 is sent to single compressor 410 for recompressing before feeding to first stage membrane 402. Here, feed gas 401 may be compressed right before or right after splitter 414 (not shown).

The disclosed two membrane stages consist of rubbery-type hollow-fiber membranes. The rubbery-type hollow-fiber membrane material may consist of poly(dimethyl siloxane) (PDMS), e.g., homopolymers of dimethylsiloxane, and copolymers of dimethyl siloxane with methylethyl siloxane, methyl propyl siloxane, methyl butyl siloxane, methyl pentylsiloxane, methyl hexyl siloane, methyloxtyl siloane, methyl phenyl siloxane. The rubbery-type hollow-fiber membrane material may include block copolymers of dimethylsiloxane or methyloctylsiloxane with polyarylethers, polyamides, polyesters, polyketones, polyimides or block copolymers of dimethyl siloxanes or methyl octyl siloxane with silicates. Another possible material is a ladder-type silicone block copolymer with a general formula of: HO{[C₆H₅SiO1.5]ₙ[Si(CH₃)₂O]ₘ}H, where n=30-60, and m=80-130.

The disclosed system and process do not require use of sophisticated PSA cycles. In particular, simple cycles with no vacuum step and limited ‘rinse’ steps may be employed for reduced energy consumption. The PSA may be composed of a 4-bed cycle previously disclosed by Brandani (Adsorption, 2021, 27:171-180). Alternatively, the PSA may include dual rotary valves such as that disclosed in U.S. Pat. No. 9,101,872.

The disclosed system and process has the following advantages which is inherent to both membrane and PSA processes. Any heavy hydrocarbons, such as ethane, propane, butanes, pentanes, and hexanes, in an incoming feed gas are selectively permeated to a product stream depleted in N₂ in the first stage membrane and serve to increase the higher heating value of a product. Any heavy hydrocarbons which proceed to the second stage membrane are selectively permeated to a recycle stream. Any heavy hydrocarbons which proceed to the PSA are selectively adsorbed and recycled to the incoming feed gas. The overall process recovers heavy hydrocarbons to the product stream in excess of 99 mol %.

The disclosed system and process may also be used in combination with a sub-ambient temperature process disclosed in U.S. Pat. No. 11,318,411. The use of sub-ambient temperature operation enhances the selectivity of both membrane stages, allowing for higher hydrocarbon recovery and/or a greater fraction of nitrogen removal from each stage membrane.

An additional embodiment may be considered which has the same general configuration as in FIG. 1, except that the first permeate still contains a nitrogen content that is too high to be used as a product. This permeate may be injected at pressure between 30 and 100 psig into a second PSA device. The second PSA would typically use kinetic adsorbents that would preferentially adsorb nitrogen and the residual gas from the second PSA will form a final natural gas product. The regenerated gas from the second PSA will be enriched in nitrogen compared to the first permeate and may be either vented/flared or recycled to a feed gas.

### EXAMPLES

The following non-limiting examples are provided to further illustrate embodiments of the invention. However, the examples are not intended to be all inclusive and are not intended to limit the scope of the inventions described herein.

### Example 1

A heat and mass balance of the process depicted in FIG. 1 is given in Table 1, which applied to a typical raw natural gas stream with 6 mol % nitrogen. A feed gas representative of natural gas and containing 6 mol % nitrogen 101 is sent to first stage membranes 102. Permeate stream 103 from first stage membrane 102 is depleted down to 3 mol % nitrogen such that it meets a typical pipeline natural gas specification for use. Residue stream 104 enriched in N₂ from first stage membranes 102 is enriched to 9.7 mol % nitrogen and sent to second stage membranes 105. Permeate stream 107 from second stage membrane 105 contains 6.0 mol % nitrogen and is recycled to feed gas 101. The system is ideally operated so that nitrogen content in permeate 107 of second stage membrane 105 nearly matches that of feed gas 101. Retentate gas 106 from second stage membrane 105 is enriched to 31 mol % nitrogen and sent to PSA beds 108. A fraction of retentate gas 106 adsorbed by PSA beds 108 is directed to PSA offgas stream 109 and is recycled to feed gas 101. The system is ideally operated so that nitrogen content in PSA offgas 109 nearly matches that of feed gas 101. Combined stream 111 is formed by mixing permeate 107 of second stage membrane 105 and PSA offgas 109 from PSA beds 108 and sent to compressor 110. Compressor 110 increases the pressure of combined stream 111 to 500 psig, equal to that of the incoming feed gas 101 such that combined stream 111 can be mixed with the incoming feed gas 101. A fraction of retentate gas 106 which is not absorbed by PSA beds 108, known as PSA overhead gas 112 is enriched to 51 mol % nitrogen and sent to vent or flare. The methane loss to PSA overhead gas 112 is sufficiently low that an overall hydrocarbon recovery of 97% is achieved on the basis of lower heating value.

TABLE 1

| | 101 | 103 | 104 | 106 | 107 | 109 | 111 | 112 |
|---|---|---|---|---|---|---|---|---|
| Temperature [° F.] | 104.0 | 94.2 | 82.2 | 25.5 | 61.9 | 4.9 | 104.0 | 12.0 |
| Pressure [psig] | 500.0 | 15.0 | 500.0 | 500.0 | 15.0 | 15.0 | 505.0 | 492.9 |
| Vol Flow [MMSCFD] | 6.00 | 5.63 | 4.96 | 0.73 | 4.23 | 0.36 | 4.59 | 0.37 |
| Mass Flow [lb/hr] | 11,890 | 10,978 | 9,690 | 1,593 | 8,097 | 686 | 8,779 | 907 |
| LHV [Btu/SCF] | 918.7 | 950.3 | 849.5 | 629.1 | 887.6 | 822.2 | 882.5 | 442.2 |
| Mole Frac (CH₄) | 0.8509 | 0.8750 | 0.8631 | 0.6856 | 0.8938 | 0.8921 | 0.8937 | 0.4856 |
| Mole Frac (N₂) | 0.0600 | 0.0299 | 0.0972 | 0.3110 | 0.0602 | 0.1012 | 0.0633 | 0.5140 |
| Mole Frac (C₂) | 0.0866 | 0.0923 | 0.0389 | 0.0035 | 0.0451 | 0.0067 | 0.0421 | 0.0003 |
| Mole Frac (C₃) | 0.0020 | 0.0022 | 0.0006 | 0.0000 | 0.0008 | 0.0000 | 0.0007 | 0.0000 |
| Mole Frac (i-C₄) | 0.0000 | 0.0000 | 0.0000 | 0.0000 | 0.0000 | 0.0000 | 0.0000 | 0.0000 |
| Mole Frac (n-C₄) | 0.0000 | 0.0000 | 0.0000 | 0.0000 | 0.0000 | 0.0000 | 0.0000 | 0.0000 |
| Mole Frac (CO₂) | 0.0005 | 0.0005 | 0.0002 | 0.0000 | 0.0002 | 0.0000 | 0.0002 | 0.0000 |

### Example 2

A heat and mass balance of the process depicted in FIG. 3 is given in Table 2, which applied to a typical raw natural gas stream with 10% nitrogen. Note that 100% of feed gas 301 is sent to separate feed stream 301b and none is sent to separate feed stream 301a. Feed gas 301 representative of natural gas and containing 10 mol % nitrogen is sent to second stage membranes 305. Permeate stream 307 from second stage membrane 305 is depleted down to 5.8 mol % nitrogen and sent to recycle compressor 310 and then to first stage membrane 302. First stage membrane 302 generates permeate stream 303 depleted in nitrogen such that it meets a typical pipeline natural gas specification of 3.0 mol %. Residue stream 304 enriched in N₂ from first stage membrane 302 is enriched to 10.4 mol % nitrogen, mixed with the incoming separate feed 301b and sent to second stage membranes 305. Retentate gas 306 from second stage membranes 305 is enriched to 23.5 mol % nitrogen and sent to PSA beds 308. A fraction of retentate gas 306 adsorbed by PSA beds 308 is directed to offgas stream 309 and is recycled to feed gas 301. The system is ideally operated so that nitrogen content in offgas stream 309 from PSA beds 308 nearly matches that of permeate gas 307 from second stage membrane 305. Combined stream 311 is formed by mixing permeate 307 of second stage membrane 305 and offgas 309 from PSA beds 308 and sent to compressor 310. Compressor 310 increases the pressure to 510 psig in combined stream 311, sufficiently high that the pressure of residue 304 from first stage membrane 302 is equal to that of the incoming feed gas 301 such that it can be mixed with the incoming feed gas 301. A fraction of retentate gas 306 which is not absorbed by PSA beds 308, known as PSA overhead stream 312 is enriched to 42 mol % nitrogen and is sent to vent or flare. Methane loss to PSA overhead stream 312 is sufficiently low so that an overall hydrocarbon recovery of 89% is achieved on the basis of lower heating value.

TABLE 2

| | 301b | 303 | 304 | 306 | 307 | 309 | 311 | 312 |
|---|---|---|---|---|---|---|---|---|
| Temperature [° F.] | 104.0 | 92.2 | 77.0 | 53.2 | 78.2 | 31.1 | 104.0 | 41.0 |
| Pressure [psig] | 500.0 | 15.0 | 500.0 | 500.0 | 15.0 | 15.0 | 510.0 | 492.9 |
| Vol Flow [MMSCFD] | 6.00 | 4.93 | 3.27 | 2.30 | 6.97 | 1.22 | 8.20 | 1.07 |
| Mass Flow [lb/hr] | 12,205 | 9,719 | 6,415 | 4,819 | 13,801 | 2,332 | 16,134 | 2,488 |
| LHV [Btu/SCF] | 882.3 | 959.8 | 843.7 | 708.8 | 921.4 | 868.7 | 913.5 | 526.4 |
| Mole Frac (CH₄) | 0.8109 | 0.8619 | 0.8546 | 0.7465 | 0.8526 | 0.8965 | 0.8590 | 0.5753 |
| Mole Frac (N₂) | 0.1000 | 0.0299 | 0.1044 | 0.2350 | 0.0576 | 0.0706 | 0.0596 | 0.4227 |
| Mole Frac (C₂) | 0.0866 | 0.1051 | 0.0402 | 0.0182 | 0.0874 | 0.0324 | 0.0792 | 0.0019 |
| Mole Frac (C₃) | 0.0020 | 0.0025 | 0.0006 | 0.0002 | 0.0020 | 0.0004 | 0.0017 | 0.0000 |
| Mole Frac (i-C₄) | 0.0000 | 0.0000 | 0.0000 | 0.0000 | 0.0000 | 0.0000 | 0.0000 | 0.0000 |
| Mole Frac (n-C₄) | 0.0000 | 0.0000 | 0.0000 | 0.0000 | 0.0000 | 0.0000 | 0.0000 | 0.0000 |
| Mole Frac (CO₂) | 0.0005 | 0.0006 | 0.0002 | 0.0001 | 0.0005 | 0.0001 | 0.0004 | 0.0000 |

### Example 3

A heat and mass balance of the process depicted in FIG. 4 is given in Table 3, which applied to a typical raw natural gas stream with 20% nitrogen. Note that 100% of feed gas 401 is sent to separate stream 401b and none is sent to separate stream 401a. Feed gas 401 representative of natural gas and containing 20 mol % nitrogen is sent to PSA beds 408. Offgas stream 409 from PSA beds 408 is depleted down to 5.9 mol % nitrogen and sent to recycle compressor 410 and then to first stage membrane 402. First stage membrane 402 generates permeate stream 403 depleted in nitrogen such that it meets a typical pipeline natural gas specification of 3.0 mol %. Residue stream 404 enriched in N₂ from first stage membranes 402 is enriched to 10.3 mol % nitrogen and sent to second stage membranes 405. Retentate gas 406 from second stage membrane 405 is enriched to 29 mol % nitrogen, combined with the incoming separate stream 401b, and sent to PSA device 408. Permeate stream 407 from second stage membranes 405 is depleted down to 6.1 mol % nitrogen. Combined stream 411 is formed by mixing permeate 407 of second stage membrane 405 and offgas 409 from PSA beds 408 and sent to compressor 410. Compressor 410 increases the pressure to 515 psig in combined stream 411, sufficiently high that the pressure of residue 404 from first stage membrane 402 is equal to that of the incoming feed gas 401 such that it can be mixed with the incoming feed gas 401. A fraction of retentate gas 406 which is not absorbed by PSA beds 408, known as PSA overhead stream 412 is enriched to 45 mol % nitrogen and is sent to vent or flare. Methane loss to PSA overhead stream 412 is sufficiently low so that an overall hydrocarbon recovery of 74% is achieved on the basis of lower heating value.

TABLE 3

| | 401b | 403 | 404 | 406 | 407 | 409 | 411 | 412 |
|---|---|---|---|---|---|---|---|---|
| Temperature [° F.] | 104.0 | 92.1 | 77.0 | 23.8 | 57.2 | 95.8 | 204 | 48.7 |
| Pressure [psig] | 500.0 | 15.0 | 500.0 | 500.0 | 15.0 | 15.0 | 515.0 | 492.9 |
| Vol Flow [MMSCFD] | 6.00 | 3.60 | 2.55 | 0.46 | 2.09 | 4.05 | 6.15 | 2.40 |
| Mass Flow [lb/hr] | 12,994 | 7,287 | 5,061 | 985 | 4,076 | 8,263 | 12,348 | 5,716 |
| LHV [Btu/SCF] | 791.4 | 984.0 | 855.9 | 643.4 | 902.2 | 945.9 | 930.9 | 503.0 |
| Mole Frac (CH₄) | 0.7109 | 0.8291 | 0.8404 | 0.6961 | 0.8718 | 0.8144 | 0.8338 | 0.5336 |
| Mole Frac (N₂) | 0.2000 | 0.0294 | 0.1031 | 0.2975 | 0.0608 | 0.0593 | 0.0600 | 0.4555 |
| Mole Frac (C₂) | 0.0866 | 0.1373 | 0.0553 | 0.0063 | 0.0659 | 0.1225 | 0.1033 | 0.0109 |
| Mole Frac (C₃) | 0.0020 | 0.0033 | 0.0009 | 0.0000 | 0.0011 | 0.0030 | 0.0023 | 0.0001 |
| Mole Frac (i-C₄) | 0.0000 | 0.0000 | 0.0000 | 0.0000 | 0.0000 | 0.0000 | 0.0000 | 0.0000 |
| Mole Frac (n-C₄) | 0.0000 | 0.0000 | 0.0000 | 0.0000 | 0.0000 | 0.0000 | 0.0000 | 0.0000 |
| Mole Frac (CO₂) | 0.0005 | 0.0008 | 0.0003 | 0.0000 | 0.0003 | 0.0007 | 0.0006 | 0.0000 |

### Example 4

A feed gas containing between 6 and 10 mol % nitrogen, 8 mol % for instance, may be separated by the process depicted in FIG. 3. In this case, a portion of feed gas 301a is sent to first stage membrane 302, and the other portion 301b is sent to second stage membrane 305. For a lower nitrogen content, close to 6 mol %, a greater portion of feed gas 301 is sent to first stage membrane via stream 301a. For a higher nitrogen content, close to 10 mol %, a greater fraction of feed gas 301 is sent to second stage membrane via stream 301b.

### Example 5

A feed gas containing between 10 and 20 mol % nitrogen, 15 mol % for instance, may be separated by the process depicted in FIG. 4. In this case, a portion of feed gas 401a is sent to second stage membrane 405, and the other portion 401b is sent to PSA beds 408. For a lower nitrogen content, close to 10 mol %, a greater portion of feed gas 401 is sent to second stage membrane 405 via separate stream 401a. For a higher nitrogen content, close to 20 mol %, a greater fraction of feed gas 401 is sent to PSA beds 408 via separate stream 401b. In this manner, the same general process design may accommodate for a wide range of feed composition while still producing a product to the same specification.

Reference herein to “one embodiment” or “some embodiments” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

As used herein, the indefinite article “a” or “an” means one or more.

As used herein, “about” or “around” or “approximately” in the text or in a claim means ±10% of the value stated.

The term “ambient pressure” refers to an environment pressure approximately 1 atm or 1 bara.

The standard abbreviations of the elements from the periodic table of elements are used herein. It should be understood that elements may be referred to by these abbreviations (e.g., Si refers to silicon, N refers to nitrogen, O refers to oxygen, C refers to carbon, etc.).

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

We claim:

1. A process for removing nitrogen from a feed gas containing at least nitrogen and methane, the process comprising the steps of:
a) introducing the feed gas into a first membrane stage to produce a first permeate enriched in methane and a first residue enriched in nitrogen;
b) forwarding the first residue enriched in nitrogen into a second membrane stage to produce a second permeate enriched in methane and a second residue enriched in nitrogen;
c) forwarding the second residue enriched in nitrogen into pressure swing adsorption (PSA) beds to produce an high pressure overhead stream containing nitrogen and a low pressure offgas stream containing methane therein;
d) combining the second permeate enriched in methane and the low pressure offgas stream containing methane to form a combined gas and forwarding the combined gas to the feed gas for recycle;
e) collecting a first permeate enriched in methane as a product; and
f) venting out the high pressure overhead stream containing nitrogen.

2. The process of claim 1, further comprising the step of:
compressing the feed gas before feeding the feed gas to the first membrane stage.

3. The process of claim 1, further comprising the step of:
compressing the combined gas before forwarding the combined gas to the feed gas for recycle.

4. The process of claim 1, further comprising the steps of: if the feed gas containing exceeding 6 mol % but not greater than 10 mol % of nitrogen,
splitting the feed gas into a first and a second feed streams;
forwarding the first feed stream to the first membrane stage, wherein the first feed stream is merged with the combined gas before forwarding the first feed stream to the first membrane stage;
forwarding the second feed stream to the second membrane stage, wherein the second feed stream is merged with the first residue enriched in nitrogen from the first membrane stage before forwarding the second feed stream to the second membrane stage; and
moderating a ratio of the feed gas in the first and second feed streams, respectively.

5. The process of claim 4, further comprising the step of:
compressing the feed gas before splitting the feed gas.

6. The process of claim 4, further comprising the step of:
compressing the combined gas before forwarding to the first membrane stage.

7. The process of claim 1, further comprising the steps of: if the feed gas containing exceeding 10 mol % but not greater than 20 mol % of nitrogen,
a) splitting the feed gas into a first and second feed streams;
b) forwarding the first feed stream to the second membrane stage, wherein the first feed stream is merged with the first residue enriched in nitrogen from the first membrane stage before forwarding the first feed stream to the second membrane stage;
c) forwarding the second feed stream to the pressure swing adsorption (PSA) beds, wherein the second feed stream is merged with the second residue enriched in nitrogen from the second membrane stage before forwarding the second feed stream to the pressure swing adsorption (PSA) beds; and
d) moderating a ratio of the feed gas in the first and second feed streams, respectively.

8. The process of claim 7, further comprising the step of:
compressing the feed gas before splitting the feed gas.

9. The process of claim 7, further comprising the step of:
compressing the combined gas before forwarding to the first membrane stage.

10. A membrane system for removing nitrogen from a feed gas containing at least nitrogen and methane, the system comprising:
a) a first membrane stage, fed with the feed gas, configured to produce a first permeate enriched in methane and a first residue containing nitrogen;
b) a second membrane stage, fed with the first residue containing nitrogen, configured to produce a second permeate enriched in methane and a second residue enriched in nitrogen;
c) a pressure swing adsorption (PSA) system containing PSA beds, fed with the second residue enriched in nitrogen, configured to produce an high pressure overhead stream containing nitrogen and a low pressure offgas stream containing methane therein; and
d) a combined gas, formed by combining the second permeate enriched in methane and the low pressure offgas stream containing methane,
wherein the combine gas is forwarded to the feed gas for recycle, the high pressure overhead stream containing nitrogen is vent out, the first permeate enriched in methane is collected as a product.

11. The membrane system of claim 10, further comprising:
a compressor, configured to compress the feed gas before the feed gas is fed to the first membrane stage.

12. The membrane system of claim 10, further comprising:
a compressor, configured to compress the combined gas before the combined gas is forwarded to the feed gas for recycle.

13. The membrane system of claim 10, further comprising: if the feed gas containing exceeding 6 mol % but not greater than 10 mol % of nitrogen,
a splitter, configured to split the feed gas into a first and a second feed streams; and
two control valves, each installed along the first and second feed streams, respectively, configured to moderate a ratio of the feed gas in the first and second feed streams,
wherein the first feed stream is fed to the first membrane stage and the second feed stream is fed to the second membrane stage.

14. The membrane system of claim 13, further comprising:
a compressor, configured to compress the feed gas before the feed gas is forwarded to the splitter.

15. The membrane system of claim 13, further comprising:
a compressor, configured to compress the combined gas before the combined gas is forward to the first membrane stage.

16. The membrane system of claim 10, further comprising: if the feed gas containing exceeding 10 mol % but not greater than 20 mol % of nitrogen,
a splitter, configured to split the feed gas into a first and a second feed streams; and
two control valves, each installed along the first and second feed streams, respectively, configured to moderate a ratio of the feed gas in the first and second feed streams,
wherein the first feed stream is fed to the second membrane stage and the second feed stream is fed to the pressure swing adsorption (PSA) system.

17. The membrane system of claim 16, further comprising:
a compressor, configured to compress the feed gas before the feed gas is forwarded to the splitter.

18. The membrane system of claim 16, further comprising:
a compressor, configured to compress the combined gas before the combined gas is forward to the first membrane stage.

19. The membrane system of claim 10, wherein the first membrane stage and the second membrane stage each comprise rubbery-type hollow-fiber membranes.

20. A process for removing nitrogen from a feed gas containing at least nitrogen and methane, when the feed gas containing exceeding 10 mol % but not greater than 20 mol % of nitrogen, the process comprising the steps of:
a) splitting the feed gas into a first and second feed streams;
b) moderating a ratio of the feed gas in the first and second feed streams, respectively;
c) forwarding the first merged gas to the second membrane stage, wherein the first feed stream is merged with a first residue enriched in nitrogen from a first membrane stage before forwarding the first merged gas to the second membrane stage;
d) forwarding the second merged gas to pressure swing adsorption (PSA) beds to produce an high pressure overhead stream containing nitrogen and a low pressure offgas stream containing methane therein, wherein the second feed stream is merged with a second residue enriched in nitrogen from the second membrane stage before the second merged gas to pressure swing adsorption (PSA) beds, and;
e) combining a second permeate enriched in methane from the second membrane stage and the low pressure offgas stream containing methane from the PSA beds to form a combined gas and forwarding the combined gas to the first membrane stage as a first stage feed gas;
f) compressing the combined gas before forwarding the combined gas to the first membrane stage;
g) collecting a first permeate enriched in methane as a product; and
h) venting out the high pressure overhead stream containing nitrogen.
